(19) United States
(12) Patent Application Publication
(10) Pub. No.: US 2007/0118424 A1
(43) Pub. Date: May 24, 2007

(54) Method and system for compensating a salesperson

(75) Inventor: Darryl Rawlings, Bowen Island (CA)

Correspondence Address: PATENT DOCKET ADMINISTRATOR;LOWENSTEIN SANDLER PC, 65 LIVINGSTON AVENUE, ROSELAND, NJ, 07068, US

(73) Assignee: Vetinsurance, Ltd.

(21) Appl. No.: 11/285,975

(22) Filed: Nov. 23, 2005

(51) Int. Cl. G07G 1/14

(52) U.S. Cl. 705/14

(57) ABSTRACT

A system and a method for compensating a salesperson of a company includes compensation based on each client assigned to an exclusive geographic territory of the salesperson, wherein the compensation continues so long as the client receives the services offered by the company. The salesperson receives continuous periodic compensation for each assigned client, regardless of whether the client registered with the company through the salesperson or independent of the salesperson. If and when the salesperson's association with the company ends, the compensation based upon the then-existing clients continues to be provided to the salesperson. Thus, the salesperson continues to be rewarded for his or her previous work efforts even when he or she is no longer working with the company, thereby increasing financial security and allowing the salesperson to retain control of his or her income.

### BACKGROUND OF THE INVENTION

1. Field of the Invention

The present invention relates generally to a method and system for compensating a salesperson, and more particularly, to a method for compensating a salesperson of a company beyond termination of the salesperson's relationship with the company.

2. Related Background

Often companies hire salespersons to offer company services directly to clients. Typically, such salespersons travel to client locations, such as offices and residencies, to offer the company's services, and are compensated for each client brought into the company. Compensation may include onetime payments, such as a commission, or may be provided on a periodic basis. Salespersons often create ongoing relationships with each client as part of performing his or her employment duties, and devote many hours towards the upkeep of such relationships.

If and when the relationship between the company and the salesperson ends, the company typically terminates compensating the salesperson and gives the salesperson's clients to another salesperson. It is quite common for the salesperson to be replaced by another salesperson who inherits the clients and compensation of the now-terminated salesperson, when the now-terminated salesperson's compensation becomes high. Often, a well-performing salesperson is replaced by a new salesperson with a revised compensation package, because the company believes that it can pay less for the same duties to be performed. This does not facilitate a productive relationship between the salesperson and the company because the salesperson has a constant concern regarding job security. Additionally, if the salesperson's compensation is based on the number of existing clients, the salesperson has a constant concern about being replaced by a lesser-paid salesperson, disregarding the time and effort put into the company's business by the salesperson.

### SUMMARY OF INVENTION

The present invention addresses the concerns discussed above. A method and a system for compensating a salesperson who markets and sells services to multiple clients are presented. For the purposes of this invention, a salesperson includes, but is not limited to, an independent contractor, an employee, a freelance contractor, and a partner. According to one embodiment of the present invention, a method for compensating the salesperson comprises providing compensation related to one or more clients assigned to the salesperson and continuing such compensation until each of the one or more clients withdraws from the services offered, thereby effectively terminating the relationships between the salesperson and the clients. For the purposes of this invention, a client includes, but is not limited to, a person or entity who receives the services and/or purchases the services directly, as well as a third-party beneficiary who receives the benefits of the services. Such termination may occur in one of two ways: first, the client may voluntarily terminate the services at any time, for example, by canceling the contract, upon which compensation to the salesperson ceases, for example, at the end of the following pay period. Alternately, the client, such as, a third-party beneficiary, may become deceased, thereby nullifying the need for the services and, at such time, compensation to the salesperson ceases. However, compensation to the salesperson does not terminate based upon the salesperson ending his or her association with the service provider or company. This method of compensation increases financial security for the salesperson and accordingly, increases loyalty towards the company, which facilitates productivity.

Additionally, the salesperson has a steady flow of compensation by knowing exactly how many clients he or she maintains and brings in, and need not be so concerned with pay periods where few clients were brought in. Compensation to the salesperson is based solely upon the number of clients assigned to the salesperson, thereby allowing the salesperson to determine how much or how little time he or she should devote to working. If the salesperson's relationship with the company is terminated, or if the salesperson is unable to perform the job required, compensation continues until the last client previously assigned to the salesperson either becomes deceased or terminates the service agreement. The salesperson does not lose his or her work efforts to another salesperson who may come into the company as a replacement. Accordingly, the company has no financial incentive for replacing an existing, good-performing salesperson, because the company cannot reduce the commissions payable due for existing clients by terminating or adjusting the pay package for any existing clients. This removes the concern by the salesperson of being replaced by a lesser-paid salesperson, and facilitates loyalty towards the company.

According to another embodiment of the present invention, a system for compensating a salesperson includes a database containing a plurality of clients stored in a computer-readable memory, one or more interfaces to allow the salesperson to access the client database, and a call center for interacting with clients and with salespersons. A client, in a particular geographic territory, may sign up for a company's services, for example, through the salesperson associated with the geographic territory, by contacting the call center, or through the company's Internet website. If through the salesperson, the salesperson may provide the client information to the call center, which in turn enters the client's information into the client database. Alternately, if the client contacts the call center directly, then the call center enter the client's information directly into the client database and then contacts the salesperson responsible for the geographic location that includes the client. The salesperson may access the client database via an interface, such as a Web interface, to review client information. The company also uses the client database in determining the compensation for the salesperson. Further, the system may include one or more computer applications to facilitate processing client intake and to generate sales reports for compensation of the salesperson.

In yet another embodiment of the present invention, a programmable computer for use in compensating a salesperson is provided. The programmable computer includes at least one memory or computer-readable medium that includes at least one region for storing computer-executable program code, and a processor for executing the program code stored in the memory. The program code includes modules for inputting new clients into a database, assigning clients to a salesperson based upon a geographical territory, and compensating the salesperson on a periodic basis based on the assigned clients within the database. Each pay period, the program code may generate sales reports for each salesperson. Such sales reports indicate whether new clients have been added to the database within the pay period as well as whether previous clients have remained enrolled with the company. The programmable computer automates compensation of the salesperson, thereby providing an efficient means for performing the payroll duties of the employer by reducing the manual time and costs often associated with such payroll duties.

### BRIEF DESCRIPTION OF THE DRAWINGS

The present invention is more readily understood from the detailed description of the embodiments presented below considered in conjunction with the attached drawings, of which:

FIG. 1 illustrates a system for compensating a salesperson, according to an embodiment of the present invention; and

FIG. 2 presents an exemplary process flow for compensating a salesperson, according to an embodiment of the present invention.

### DETAILED DESCRIPTION OF THE INVENTION

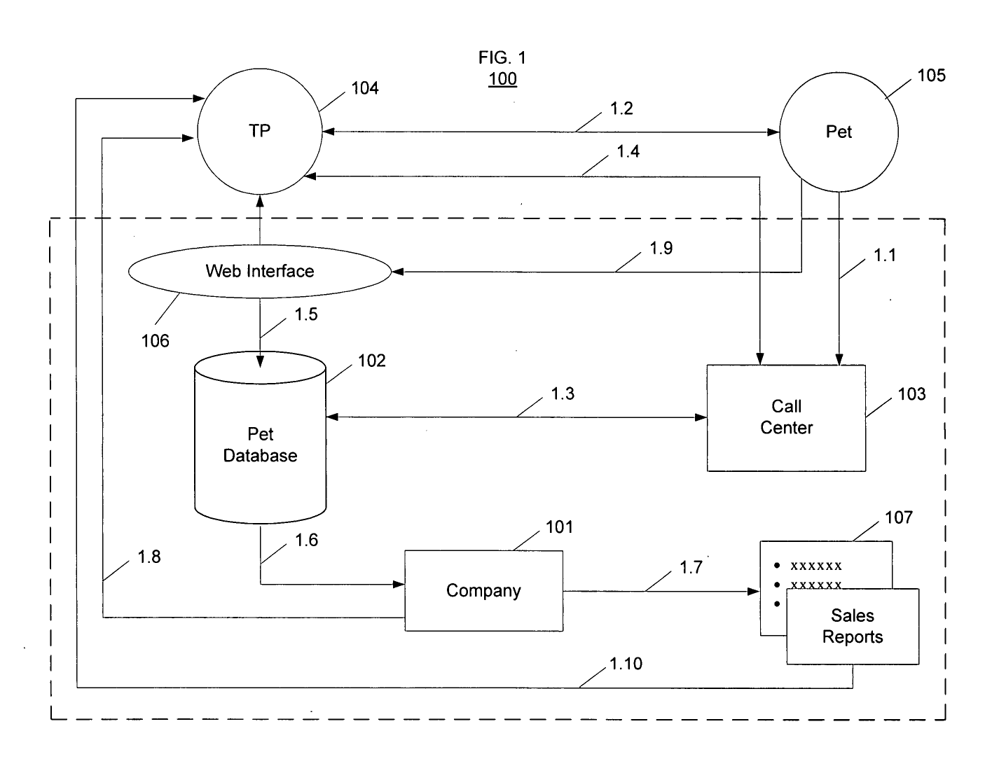

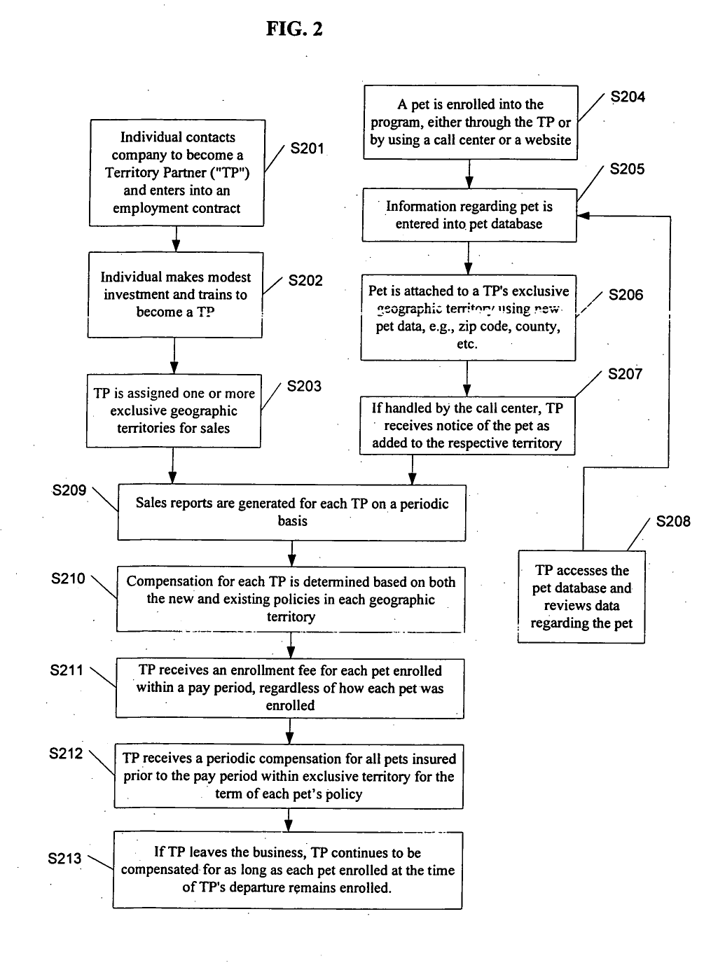

FIGS. 1 and 2 are discussed together to describe an exemplary embodiment of the present invention. FIG. 1 presents a system 100 for compensating a salesperson, according to an embodiment of the present invention. FIG. 2 illustrates steps in a process flow describing an exemplary embodiment of the present invention. The steps need not be in the sequence illustrated, and some steps may be essentially simultaneous. In the embodiments described below, an insurance company provides health insurance for pets. However, the disclosed system and method may be used for the sale of any type of insurance product or a product where there is a continuing obligation for a client to pay for a particular service.

In this embodiment, the company 101 seeks to develop quasi-partnerships with salespersons to market health insurance policies to pet owners at veterinary clinics. At step S201, an individual may contact the insurance company in order to become a salesperson or a Territory Partner (“TP”) 104. Each Territory Partner 104 is assigned one or more exclusive geographic territories where the TP 104 is responsible for the clients located in each territory. Upon entering into an agreement with company 101, where such an agreement may be, for example, an employment contract, a sales contract, or a distribution contract, at step S202, TP 104 makes an investment into the company 101 in exchange for proper training, marketing materials to provide to prospective clients, and to cover other miscellaneous expenses, such as obtaining a license for accessing and using the company's client database 102. This method fosters a partnership environment such that by investing his or her own finds, TP 104 is a “partner” of company 101. Once completing the required training, at step S203, company 101 assigns one or more exclusive geographic territories to TP 104. Each geographic territory includes multiple veterinary clinics where TP 104 may distribute marketing materials and also may market directly to pet owners. The geographic territories may be categorized by zipcode, by county, or by some other category.

At step S204, a pet owner may enroll a pet 105, the client, into one or more insurance programs offered by company 101 either directly through TP 104, as shown at 1.2 in FIG. 1, or by contacting company 101 directly, such as through a call center 103, as shown at 1.1, or via a company Web interface 106, as shown at 1.9. Upon enrollment, at step S205, information regarding pet 105 is entered into a pet database 102. Pet information may be entered into the pet database 102 either by call center 103, as shown at 1.3, or by TP 104, as shown at 1.5, via the Web interface 106.

At step S206, each pet is assigned to TP 104 based on the pet's geographical location. If pet 105 registered for insurance independent of TP 104, then, at step S207, TP 104 receives notice of pet 105 as added to his or her geographic territory, from the call center 103, as shown at 1.4. Alternately, if TP 104 enrolled pet 105, TP 104 may contact the call center 103 and provide the pet information, as shown at 1.4, in order for the call center 103 to enter the related pet information into the pet database 102, or optionally, TP 104 may enter the pet information directly into the pet database 102, as shown at 1.5. Once information regarding pet 105 has been entered into the pet database 102, at step S208, TP 104 may access the pet database 102 at any time to review the information for each pet enrolled within the TP's exclusive territory.

To determine the proper compensation for TP 104, sales reports 107 may be generated on a periodic basis by company 101, for example, on a monthly basis, at S209. To do so, company 101 accesses the pet database 102, as shown at 1.6, and uses one or more software applications to query the database 102 for all registered pets assigned to TP 104 as of the query date. Company 101 also queries the pet database 102 for data regarding which pets enrolled within the last pay period, such as the last month, and which pets that enrolled prior to the pay period have remained enrolled. Upon retrieving the data, company 101 generates a sales report 107, as shown at 1.7, which may be provided to TP 104, as shown at 1.10.

At step S210, compensation is determined from the TP's sales report 107. At step S211, TP 104 receives a monthly compensation for each pet that has maintained an insurance policy up to the time the sales report 107 is generated, such as, for example, $2 per pet, as shown at 1.8. Additionally, as shown at step S212, for each pet enrolled within the pay period of the sales report 107, such as pet 105, TP 104 receives a one-time enrollment fee, such as, for example, $10, regardless of whether pet 105 enrolled through TP 104, or through call center 103 or the Web interface 106. Thus, TP 104 essentially is guaranteed compensation for each pay period, so long as the current pets remain enrolled. TP 104 may work as little or as much as he or she wishes, thereby maintaining control of his or her compensation. Additionally, TP 104 is aware of the exact amount of compensation he or she will receive each pay period since TP 104 may access the pet database 102 and query his or her own client information.

Compensation to TP 104 repeats each pay period, regardless of whether TP 104 remains associated with company 101. Thus, at step S213, if TP 104 were to either leave or be terminated from company 101, TP 104 would no longer receive the $10 enrollment fee for each new pet added within TP's territory, after TP's employment ends. However, TP 104 would continue to receive the $2 fee for each pet enrolled at the time TP's employment ends, so long as each pet remains insured with company 101. Accordingly, the system and the method of the present invention provide financial security to TP 104 regardless of whether TP's association with company 101 remains intact, and foster a productive and loyal relationship between company 101 and TP 104 by allowing TP 104 to maintain control of his or her compensation.

The inventive method also may be embodied in computer-executable code that is stored on a computer-readable medium, for example, a floppy disk, a hard drive, removable media, an optical memory, a magneto-optical memory, a RAM, a ROM, a flash memory, so-called “memory sticks,” and the like. The code may be coupled with a processor and one or more applications within the system described above to facilitate compensating the salesperson automatically, thereby reducing manual time and costs associated with common payroll management.

While the present invention has been described with respect to what is presently considered to be preferred embodiments, it is to be understood that the invention is not limited to the disclosed embodiment. To the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. A method of compensating a salesperson of a company based upon an offering of services to at least one client comprising the steps of:
providing a compensation to the salesperson during and after the salesperson's association with the company, wherein the compensation is related to the at least one client; and
terminating the compensation to the salesperson when the at least one client ceases to receive the services offered.

2. The method according to claim 1, wherein the at least one client is a purchaser of the services offered.

3. The method according to claim 1, wherein the at least one client is a third-party beneficiary of the services offered.

4. The method according to claim 1, further comprising the step of assigning at least one geographic territory for sales to the salesperson.

5. The method according to claim 4, further comprising the step of assigning the at least one client to the salesperson based upon the at least one geographic territory.

6. The method according to claim 1, wherein the step of terminating compensation is based on termination of a service agreement between the at least one client and the salesperson.

7. The method according to claim 1, wherein the step of providing compensation further comprises compensating the salesperson independent of how the at least one client registers with the company.

8. The method according to claim 7, wherein the step of providing compensation further comprises relating the compensation to the at least one periodic sales report.

9. The method according to claim 1, further comprising the step of generating at least one periodic sales report related to the salesperson and based on the at least one client.

10. Computer-executable code for determining compensation for a salesperson of a company stored on a computer-readable medium, said code comprising:
code for providing compensation to the salesperson during and after the salesperson's association with the company, wherein the compensation is related to the at least one client; and
code for terminating the compensation to the salesperson when the at least one client ceases to receive the services offered.

11. The computer-executable code according to claim 10, further comprising the step of assigning at least one geographic territory for sales to the salesperson.

12. The computer-executable code according to claim 11, further comprising code for assigning the at least one client to the salesperson based upon a geographic territory.

13. The computer-executable code according to claim 10, further comprising code for generating periodic sales reports related to the salesperson and based on the at least one client, wherein compensation to the salesperson is attributed to the sales reports.
